(19) United States
(12) Patent Application Publication
(10) Pub. No.: US 2002/0061380 A1
(43) Pub. Date: May 23, 2002

(54) MULTI-LAYER SURFACE COVERING

(76) Inventors: CAROL CORPUS, WESTLAKE, OH (US); THOMAS A. CORPUS, STRONGSVILLE, OH (US)

Correspondence Address: DEBORAH LIU, AMIN & TUROCY, LLP, 24TH FLOOR, NATIONAL CITY CENTER, 1900 EAST 9TH STREET, CLEVELAND, OH, 44114, US

(21) Appl. No.: 09/344,411

(22) Filed: Jun. 26, 1999

(51) Int. Cl. B32B 7/06

(52) U.S. Cl. 428/40.1

(57) ABSTRACT

A surface covering provides multiple new top leaves on a surface to be covered. The surface covering includes a stack of leaves having at least a first leaf and a last leaf, such that the first leaf forms a covering surface. Each of the leaves includes a first surface adapted to serve as a covering surface, a leaf adherent for removably connecting the plurality of leaves to each other, and a second surface that opposes the first surface and is removably connected to the first surface of an adjacent leaf by the leaf adherent. The first leaf may be removed from the adjacent leaf such that the adjacent leaf becomes the first leaf The last leaf comprises a first surface adapted to serve as the covering surface and an opposing second surface. A leaf adherent connects the second surface of the last leaf to a surface to be covered.

### TECHNICAL FIELD

The invention concerns surface coverings. More particularly, the invention concerns a multi-layer surface covering for protecting or decorating surfaces in which a top layer of the surface covering may be removed when no longer desired.

### BACKGROUND OF THE INVENTION

In recent years repositionable adhesive has been developed with reduced adhesive strength when compared to permanent bonding adhesives. Repositionable adhesive may be used to bond individual sheets of paper together to form a pad while allowing the sheets to be separated with relative ease and without damage to the remaining leaves. Repositionable adhesives have been used, for example, in the manufacture of note pads. However,

a.) the surface of the last or bottom note of the note pad has the same adhesive strength as other sheets in the note pad;

b.) there is generally a thin strip of adhesive on the underside of each note of the note pad;

c.) the last note is typically covered so that it does not adhere to other surfaces; and

d.) the notes of the note pad are not intended to protect an underlying surface.

Tacky floor mats have been developed using adhesives having a similarly reduced adhesive strength. Tacky floor mats present a relatively sticky top surface aimed at removing debris from the shoes of persons stepping on the mat. The sticky top surface is achieved using a coating of adhesive having a reduced adhesive strength. This same coat of adhesive is used to bond individual floor mats into a pad-like stack while allowing the top mat to be removed without damage to the mat below.

Protective shields for medical instruments such as lamps also use reduced strength adhesives. A surface covering having a bottom surface coated with adhesive is provided to be temporarily affixed to the instrument to be protected. The reduced strength of the adhesive allows for relatively easy removal of the surface covering without damage to the instrument.

### SUMMARY OF THE INVENTION

In general, a multi-layer surface covering is provided in the form of a stack of leaves from which an outer leaf may be removed to present a new top leaf. The multi-layer surface covering provides multiple new outer leaves upon a surface to be covered. One may cover a surface for many reasons such as protection, decoration or cleanliness. The surface covering is advantageous in that it avoids the problem of surface coverings such as shelf paper or wall paper that are individually adhered to a surface and as a result are replaced only after substantial time and effort.

A multi-layer surface covering comprises at least two leaves arranged to form a stack of leaves. The pad of leaves comprises a first leaf and a last leaf and optionally has at least one intermediate leaf therebetween. The first leaf forms the top covering. Each leaf comprises a first surface which is adapted to serve as the top covering surface and an opposing second surface. The leaves are peelably bonded to one another with an adhering means. The first leaf may be removed from the stack of leaves such that a new first leaf is exposed. The second surface of a leaf is connected to the next adjacent leaf. The force by which the second surface of the last leaf is connected to the surface to be covered may be greater than the force with which the leaves are adhered to one another to prevent lifting of the entire stack when individual leaves are removed.

A leaf adhesive may be applied to the second or lower surface of the leaves to bond the leaves to one another to form a stack of leaves. The second surface of each leaf may be removably or peelably adhered to the first surface of an adjacent (e.g., lower) leaf by the leaf adhesive. Also, an adhesive may be applied to the first surface of the leaves to attract miscellaneous particles or articles, such as crumbs, although such an adhesive is not necessary to the present invention. Preferably, the adhesive strength of the adhesive on the second surface is greater than that of the adhesive applied to the first surface. The purpose of the adhesive applied to the second surface is to hold the leaves together.

The multi-layer surface covering may be provided in a generic shape to be cut to size by a user, or it may be pre-cut to fit a predetermined surface to be covered.

The multi-layer surface covering may have leaves that are transparent, translucent, colored, plain, leaves with designs or with textures for reducing slippage or increasing gripping, leaves made from materials with absorbing properties, and leaves made from screen like material to facilitate drying, or any combination thereof The thickness of the leaves may vary. For example, the last leaf of the stack may be thicker to improve the structural integrity of the multi-layer surface covering. The multi-layer surface covering may have leaves which are treated with active agents such as anti-bacterial agents, disinfectants, insect repellants, fragrances, fluid resistant agents, or anti-mildew agents.

The last leaf of the multi-layer surface covering is preferably connected to the surface to be covered by an adhesive. The advantage of having the last leaf connected to the surface to be covered is, of course, to prevent the multi-layer covering from moving from its desired position. Furthermore, the adhesive on the second surface of the last leaf may be more permanent such as in the nature of shelf paper or wallpaper adhesive.

These and other advantages, features and aspects of the invention will become apparent upon reading the following detailed description and upon reference to the accompanying drawings.

### BRIEF DESCRIPTION OF THE DRAWINGS

FIG. 1 illustrates a perspective view of a multi-layer surface covering;

FIG. 2 illustrates a cross-sectional view of the multi-layer surface covering of FIG. 1;

FIG. 3 illustrates a perspective view of a multi-layer surface covering having tabs;

FIG. 4 illustrates a plan view of a lower surface of a leaf of a multi-layer surface covering; and

FIG. 5 illustrates a perspective view of a multi-layer surface covering.

### DETAILED DESCRIPTION OF PREFERRED EMBODIMENTS

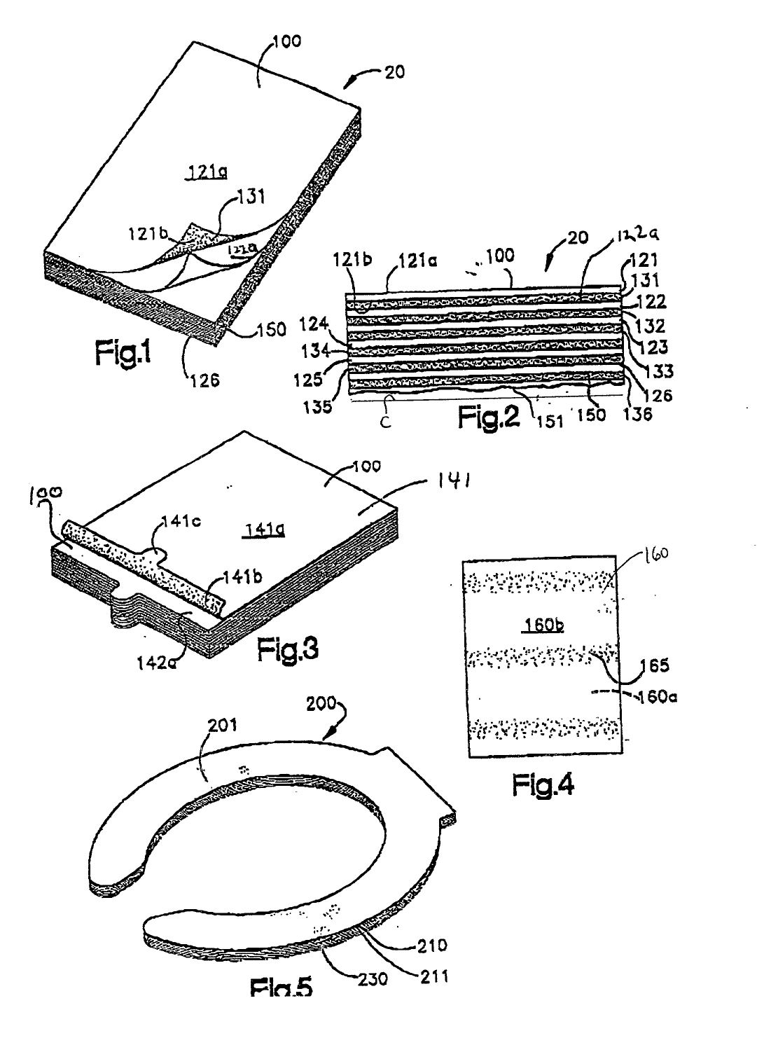

FIG. 1 illustrates a multi-layer surface covering 20 constructed in accordance with the present invention, such as for covering a shelf The multi-layer surface covering 20 comprises a top surface 100 and a bottom surface 150. The top surface 100 may have a substantially smooth, non-adhesive finish adapted to protect, clean, or decorate surfaces such as shelves from bacteria, spills and the like. The bottom surface 150 contacts the surface to be protected, decorated, cleaned, or covered. In one embodiment, the multi-layer surface covering 20 may be connected to the shelf surface by a mounting adhesive layer 136 shown in FIG. 2. Prior to installation, the adhesive layer may be covered with a protecting sheet 151 also shown in FIG. 2. In other embodiments (not shown), the multi-layer surface covering 20 may be connected to the shelf surface by other means such as thumbtacks, which will be described in more detail hereafter.

The multi-layer surface covering 20 is provided in a generic shape large enough to accommodate common household or other surfaces to be protected, decorated, cleaned, or covered. A user may cut the multi-layer surface covering to shape prior to installing it on the surface to be covered. Alternatively, FIG. 5 illustrates a multi-layer surface covering 200 which is pre-cut to the shape of a specific surface to be covered, a toilet seat.

Referring back to FIGS. 1 and 2, the multi-layer surface covering 20 comprises a plurality of leaves 121, 122, 123, 124, 125, 126. While six leaves are shown in FIG. 2, any number of leaves is contemplated as long as the stack includes at least two leaves (a first leaf and a last leaf). At least one intermediate leaf is preferably employed between the first and last leaves.

This description will discuss the characteristics of a top leaf 121 and its interaction with an adjacent leaf 122 for the sake of clarity, with the understanding that the other leaves may have the same characteristics and relative interaction. It will be apparent to those skilled in the art that the description will apply to all leaves which make up the multi-layer surface covering 20. An upper leaf surface 121a preferably has a smooth, non-adhesive finish which may be liquid resistant and decorated with designs in the case of shelf paper, for example. A lower leaf surface 121b of the top leaf is adapted to retain that leaf to the upper surface 122a of the adjacent leaf. In the embodiment illustrated in FIGS. 1 and 2 a leaf adhesive 131 is applied to a portion of the lower leaf surface 121b. For example, FIG. 4 illustrates the back of a leaf 160 having an upper leaf surface 160a and a lower leaf surface 160b. Leaf adhesive 165 is applied on lower leaf surface 160b in a stripe like pattern or other suitable manner such as substantially completely covering the top surface 160b. While the use of adhesive to bond the leaves is disclosed, other leaf adhering means such as crimping are contemplated by the invention.

The plurality of leaves 121-126 are arranged in a stack such that the upper leaf surface 121a serves temporarily as the top covering surface 100. The lower leaf surface 121b of the first leaf is adapted to separate from upper surface 122a of the adjacent leaf 122 without tearing or retaining an adhesive residue on the surface 122a. Paper having a thin plastic coating at least on the non-adhesive side or thin sheets of plastic, vinyl, cloth, wall paper, or the like, any type of shelf paper or other thin, flexible surface covering, or any perforated surface covering, may be appropriate for use as leaves. The lower leaf surface 121b is releasably adhered to the upper leaf surface 122a of the adjacent leaf It is not the intent of the present invention to delineate specific manufacturing process parameters and/or materials for either a leaf substrate or a leaf adhesive, which is within the purview of those skilled in the art in view of this disclosure, but rather to prescribe the structural combination and orientation of commercially available materials so as to define a product useful for covering or shielding surfaces.

The user installs the multi-layer surface covering 20 by connecting the bottom surface 150 to a surface C to be covered. As already discussed, the bottom surface 150 may be connected to the surface to be covered using adhesive that peelably, repositionably, or permanently bonds a leaf to the surface to be covered. The adhesive strength or retaining force of the mounting adhesive 136 of the bottom leaf should be greater than or equal to the adhesive strength or retaining force of the leaf adhesive for optimal results (e.g., leaf adhesive 131). The upper leaf surface 121 a serves as the top covering surface 100. When the upper leaf surface 121a is no longer desirable, the user peels away leaf 121 to expose the upper leaf surface 122a as the new top covering surface 100, and so on for the additional leaves. Peeling may be facilitated by providing a non-adhesive edge or section (not shown) around a portion of the leaf surface, such as on the bottom leaf surface 121b. The second surface 121b comprising less than 30% of its surface area with no adhesive is thought adequate for maintaining the viability of the adhesive properties of this invention. A leaf 141 having a peel facilitating tab 141c is shown in FIG. 3. Tab 141c has a first surface and a second surface. The user may grip the tab 141c to peel the leaf 141 away to expose 142a as the new top covering surface 100.

The invention is particularly adapted for use as shelf paper. The stack of leaves or shelf paper is cut to size by the manufacturer or user and placed as covering on the surface C to be covered such as a shelf. Typically, the paper would have a decorative pattern on each outer surface. The paper may also employ a protective coating to increase its life and provide resistance to soiling from spills. The adhesive strength of the upper layers (e.g., adhesive 131) may be less than that of the mounting adhesive layer 136. This advantageously allows the user to remove sheets as necessary without pulling the entire stack from the shelf However, the adhesive strength of the mounting adhesive layer 136 may be similar to the leaf adhesive strength (e.g., adhesive 131) if steps are taken to carefully remove each leaf without lifting the stack from the covering surface.

The particular adhesive, adhesive thickness and adhesive strength that are suitable for use in the present invention would be apparent to or empirically determinable by one skilled in the art in view of this disclosure. The adhesive strength of the leaf adhesive 131, 132, 133, 134 and 135 is that which is sufficient to prevent wrinkling due to movement of the paper during use but which enables easy removal of the leaves from the stack. For purposes of example only, an appropriate leaf adhesive may have an adhesive strength of less than 150 g/cm such that leaves are properly retained during normal use, but may be easily separated without damage to the leaves. On the other hand, the adhesive strength of the mounting adhesive 136 should be that which is sufficient to prevent lifting of the stack during removal of the individual leaves. Mounting adhesive 136 may be peelably or removably adhered to the surface to be covered, or more permanent in nature like wall paper paste, where a solvent may be required to remove the adhesive from the surface to be covered. Adhesives possessing these characteristics and which avoid leaving difficult-to-remove residues on the other leaves or shelf and which bond to the various types of shelf material (tile, formica and the like), which are suitable for use in the invention would be apparent to one skilled in the art in view of this disclosure. Instead of adhesives, non-adhesive means (such as removable clips) for securing the leaves together may be used.

Moreover, non-adhesive means for securing the leaves to each other and the stack of leaves to the surface to be covered may also be used. For example, the leaves may be paper clipped together and the stack may be clipped to the surface to be covered. Velcro™ brand loop and hook fasteners may be used to adhere the leaves to each other and/or the last leaf to the surface to be covered. Thumb tacks may be used to hold the stack of leaves to each other and/or to the surface to be covered. Double-sided tape or foam may be used to hold the stack of leaves together and to hold the last leaf to the surface to be covered. A piece of elastic or plastic with adhesive may attach to the edge of the stack of leaves and travel underneath to the surface to be covered attaching to the opposite edge of the stack of leaves, thus holding the stack of leaves to be covered. Other suitable means for connecting the leaves to each other and/or the last leaf to the surface to be covered would be appreciated by those skilled in the art in view of this disclosure.

Various means may be used to peel the first leaf from an adjacent leaf (i.e., from an intermediate leaf or from the last leaf). For example, a tab or series of tabs along the edge or edges of each leaf, may be used. The tabs on the various leaves may aligned or staggered. A non-adhesive edge may be left on the second surface of each leaf. The most desirable location for the non-adhesive section or sections is along the edges of the leaves, or in the corners. The non-adhesive edge may be identified by color or left uncolored and assists in lifting of the leafs. An elongated member such as a filament or a string between the leaves may be used so as to expose a portion of the filament or the like to the user. Pulling the filament assists in removing the leaf. The surface area of each leaf may be varied such as by having each successive leaf, from top to bottom, get slightly smaller or such as by varying the surface area of each successive leaf, from bottom to top, so as to get slightly smaller. Also, to help retain fluids of miscellaneous particles on the first surface of the top leaf, the edges of the leaves may have a raised portion or lip. A section of the first surface of the leaves may be textured to assist in lifting of the leaf. An adhesive on the first surface of the leaf or the first surface of the tab may assist in lifting the leaf. The edges of each leaf may be beveled or have a lip to assist in lifting each leaf. Also, there may be nubs on the edge of the first surface of the leaf or the tab to assist in lifting of the leaf. Other suitable means for facilitating peeling of the fist leaf from other leaves would be appreciated by those skilled in the art in view of this disclosure.

Other adaptations and uses of the present invention are contemplated. For example, the edges of the leaves may be sculptured or contoured to enhance their appearance. The leaves may be opaque or translucent and may have varying colors and patterns throughout the stack or may be of uniform color and pattern. The number of leaves may vary from few to many. Besides the toilet seat cover depicted in FIG. 5, the invention may be adapted for use on, for example, dining and picnic tables, countertops, medical examination tables, sterile work surfaces used in food processing and preparation, baby changing tables and cribs, to decorate or protect walls, car floor mats, the floor area around a toilet, and laundry sorting areas in the home and Laundromats.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A surface covering comprising:
(a) leaves arranged to form a stack of said leaves having at least a first leaf and a last leaf, such that said first leaf forms an outer covering surface, each of said leaves comprising:
(i) a first surface adapted to serve as said covering surface; and
(ii) a second surface that opposes said first surface and comprises leaf adhesive covering substantially the entire said second surface, said second surface adhering by said leaf adhesive to said first surface of an adjacent said leaf whereby said first leaf may be removed from the adjacent said leaf such that said adjacent said leaf becomes said first leaf, and
(b) wherein said last leaf comprises a first surface adapted to serve as said covering surface and an opposing second surface; and
(c) wherein said leaf adhesive disposed on said second surface of said last leaf is adapted to mount said stack to a surface to be covered.

2. The surface covering of claim 1 comprising at least one intermediate leaf disposed between said first leaf and said last leaf.

3. The surface covering of claim 1 wherein said first surface of said leaves is without adhesive.

4. The surface covering of claim 1 wherein said first surface of said leaves comprises adhesive.

5. The surface covering of claim 1 wherein said first surface of said leaves is textured.

6. The surface covering of claim 1 wherein said leaf adhesive on leaves other than said last leaf has an adhesive strength allowing a leaf to be adhered to and peelably removable from the adjacent said leaf.

7. The surface covering of claim 1 wherein said leaves are comprised of flexible material.

8. The surface covering of claim 1 wherein said first surface of said leaves comprises an active agent.

9. The surface covering of claim 1 further comprising a leaf adhesive protector disposed on said second surface of said last leaf.

10. The surface covering of claim 1 further comprising peeling means for facilitating peeling of said leaves from an adjacent said leaf.

11. The surface covering of claim 10 wherein said peeling means comprises at least one non-adhesive section disposed on said second surface of said leaves covering no more than 30% of the entire surface area of said second surface of said leaves, said at least one non-adhesive section being able to be accessed by a user to peel said leaves from said stack.

12. The surface covering of claim 10 wherein said peeling means comprises a tab with a first and second surface integral to each of said leaves adapted to be accessed by a user to peel said leaves from said stack.

13. The surface covering of claim 12 wherein said second surface of said tab comprises an adhesive.

14. The surface covering of claim 12 wherein said first surface of said tab comprises an adhesive.

15. The surface covering of claim 12 wherein said first and second surfaces of said tab comprise an adhesive.

16. The surface covering of claim 10 wherein said peeling means comprises an elongated component disposed between adjacent said leaves having a portion that is exposed to a user to facilitate peeling.

17. The surface covering of claim 1 wherein said covering is precut to correspond to dimensions of a specific surface to be covered.

18. A multi-layer surface covering comprising:
(a) a plurality of leaves arranged to form a stack of said leaves having at least a first leaf and a last leaf, such that said first leaf forms an outer covering surface, each of said leaves, excluding the last leaf comprising:
(i) a first surface adapted to serve as said covering surface; and
(ii) a second surface that opposes said first surface comprising a leaf adhesive, said second surface of each of said leaves adhering by said leaf adhesive to said first surface of an adjacent said leaf whereby said first leaf may be removed from the adjacent said leaf such that the adjacent said leaf becomes said first leaf; and
(b) wherein said last leaf comprises a first surface adapted to serve as said covering surface and an opposing second surface; and
(c) a mounting adhesive layer disposed on the second surface of said last leaf and having greater adhesive strength than the adhesive strength of said leaf adhesive.

19. A method for covering a surface comprising:
(a) covering said surface with a covering for effecting one of protection, decoration, and cleanliness comprising leaves arranged to form a stack of said leaves having at least a first leaf and a last leaf, such that said first leaf forms an outer covering surface, each of said leaves comprising:
(i) a first surface adapted to serve as said covering surface; and
(ii) a second surface opposing said first surface and comprising a leaf adhesive, said second surface of each of said leaves peelably adhering by said leaf adhesive to said first surface of an adjacent said leaf whereby said first leaf may be removed from the adjacent said leaf such that the adjacent said leaf becomes said first leaf;
(iii) wherein said last leaf comprises a first surface adapted to serve as said covering surface, a second surface opposing said first surface of said last leaf, and a leaf adhesive layer disposed on said second surface of said last leaf; and
(b) affixing said stack to said surface to be covered by contacting said leaf adhesive layer on the second surface of said last leaf with said surface to be covered; and
(c) peeling off said first leaf when said first leaf is no longer desired to reveal the first surface of the adjacent said leaf.

20. The method of claim 19 comprising at least one intermediate leaf disposed between said first leaf and said last leaf.

21. The method of claim 19 wherein said first surface of said leaves is without adhesive.

22. The method of claim 19 wherein said first surface of said leaves comprises adhesive.

23. The method of claim 19 wherein said first surface of said leaves is textured.

24. The method of claim 19 wherein said leaf adhesive has an adhesive strength allowing a leaf to be adhered to and peelably removable from the adjacent said leaf.

25. The method of claim 19 wherein said leaves are comprised of flexible material.

26. The method of claim 19 wherein said first surface of said leaves comprises an active agent.

27. The method of claim 19 further comprising a leaf adhesive protector disposed on said second surface of said last leaf.

28. The method of claim 19 further comprising peeling means for facilitating peeling of said leaves from an adjacent said leaf.

29. The method of claim 28 wherein said peeling means comprises at least one non-adhesive section disposed on said second surface of said leaves covering no more than 30% of the entire surface area of said second surface, said at least one non-adhesive section being able to be accessed by a user to peel said leaves from said stack.

30. The method of claim 28 wherein said peeling means comprises a tab with a first and second surface integral to each of said leaves adapted to be accessed by a user to peel said leaves from said stack.

31. The method of claim 30 wherein said second surface of said tab comprises an adhesive.

32. The method of claim 30 wherein said first surface of said tab comprises an adhesive.

33. The method of claim 30 wherein said first and second surface of said tab comprise an adhesive.

34. The method of claim 28 wherein said peeling means comprises an elongated component disposed between adjacent said leaves having a portion that is exposed to a user to facilitate peeling.

35. The method of claim 19 wherein said covering is precut to correspond to dimensions of a specific surface to be covered.

36. A method for covering a surface comprising:
(a) covering a surface to be covered with a covering comprising a plurality of leaves arranged to form a stack of said leaves having at least a first leaf and a last leaf, such that said first leaf forms an outer covering surface, each of said leaves comprising:
(i) a first surface adapted to serve as said covering surface;
(ii) a second surface opposing said first surface; and
(iii) means for removably connecting said leaves together, said second surface of each of said leaves being removably connected to said first surface of an adjacent said leaf whereby said first leaf may be removed from the adjacent said leaf such that the adjacent said leaf becomes said first leaf;
(iv) wherein said last leaf comprises a first surface adapted to serve as said covering surface and a second surface opposing said first surface of said last leaf, and
(v) mounting means for connecting said stack of leaves to said surface to be covered;
(b) affixing said stack of said leaves to said surface to be covered by using said mounting means to connect said last leaf to said surface to be covered; and
(c) removing said first leaf when said first leaf is no longer desired to reveal a covering surface of the adjacent said leaf.

37. The method of claim 36 wherein said second surface of said last leaf has no adhesive and said stack of leaves is placed on said surface to be covered such that the stack is non-adhesively attached to the surface to be covered.

38. A surface covering comprising:
(a) leaves arranged to form a stack of said leaves having at least a first leaf and a last leaf, such that said first leaf forms an outer covering surface, each of said leaves, excluding the last leaf, comprising:
(i) a first surface adapted to serve as said covering surface; and
(ii) a second surface that opposes said first surface and comprises leaf adhesive, said second surface adhering by said leaf adhesive to said first surface of an adjacent said leaf whereby said first leaf may be removed from the adjacent said leaf such that said adjacent said leaf becomes said first leaf; and
(b) wherein said last leaf comprises a first surface adapted to serve as said covering surface and an opposing second surface; and
(c) wherein said second surface of said last leaf comprises no leaf adhesive.

39. The surface covering of claim 38 comprising at least one intermediate leaf disposed between said first leaf and said last leaf.
